(19) United States
(12) Patent Application Publication
(10) Pub. No.: US 2016/0112363 A1
(43) Pub. Date: Apr. 21, 2016

(54) SYSTEM AND METHOD FOR AUTOMATED REMINDERS FOR A DATING SERVICE

(71) Applicant: Coffee Meets Bagel, Inc., San Francisco, CA (US)

(72) Inventor: Barnaby Jackson, San Francisco, CA (US)

(73) Assignee: COFFEE MEETS BAGEL, INC., San Francisco, CA (US)

(21) Appl. No.: 14/884,895

(22) Filed: Oct. 16, 2015

Related U.S. Application Data
(60) Provisional application No. 62/065,143, filed on Oct. 17, 2014.

(51) Int. Cl. H04L 12/58

(52) U.S. Cl. CPC H04L 51/32; H04L 51/14; H04L 51/046

(57) ABSTRACT

A system and method for generating and outputting automated reminder messages for a computer-based dating service is disclosed. An indication from a user computing device associated with a user can be received, where the indication can be indicative of interest of a user in connecting with another user. Temporary contact addresses for each user can be generated and output. Each temporary contact address can be active for an activated period of time. Any electronic communication received during the activated period can be forwarded to the appropriate user. A reminder message can be output to a particular user when: (i) the particular user has not responded to an electronic message from the other user for a response period of time, and/or (ii) the particular user has not sent an electronic message to the other user and there is less than a threshold of remaining time in the activated period.

### CROSS-REFERENCE TO RELATED APPLICATION

This application claims the benefit of U.S. Provisional Application No. 62/065,143, filed on Oct. 17, 2014. The disclosure of the above application is incorporated herein by reference in its entirety.

### FIELD

The present disclosure relates to on-line dating and, more specifically, to a system and method for providing automated reminders to individuals that have expressed mutual interest in one another.

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

Whether accurate or not, there is a perception that it is becoming more and more difficult for a person to meet and connect with others for the purpose of dating. Although the refrain “why are all of the good ones taken?” has been around for a long time, it does seem that it is more challenging to meet and connect with like-minded individuals in the increasingly technological world.

Because of the omnipresence of computers and the Internet, individuals are turning more and more to computer- or Internet-based dating services to assist with meeting people. Such computer-based dating services have many advantages over more “traditional” ways of meeting people. For example only, some of these services attempt to match people with the same or similar interests in order to find the right connection between people. The hope is that people that have similar interests are more compatible and will make more a more solid connection, resulting in a greater likelihood of a successful relationship, which is the goal for most dating services.

### SUMMARY

In some implementations of the present disclosure, a computer-implemented method for generating and outputting automated reminder messages for a computer-based dating service is disclosed. The method can include receiving, at a computing device having one or more processors, an indication from a first user computing device associated with a first user. The indication can be indicative of interest of the first user in connecting with a second user. The method can further include receiving, at the computing device, an indication from a second user computing device associated with the second user, where the indication is indicative of interest of the second user in connecting with the first user.

The method can additionally include generating, at the computing device, a temporary contact address for each of the first and second users. Each temporary contact address can be active for an activated period of time, which can be a fixed or editable amount of time. Also, the method can include outputting, at the computing device, the temporary contact address associated with the second user to the first user, and outputting, at the computing device, the temporary contact address associated with the first user to the second user. The method can include forwarding, from the computing device and to the second user, any electronic communication from the first user addressed to the temporary contact address associated with the second user during the activated period. Additionally, the method can include forwarding, from the computing device and to the first user, any electronic communication from the second user addressed to the temporary contact address associated with the first user during the activated period.

Additionally or alternatively, the method can include outputting, from the computing device, a reminder message to each particular user of the first and second user when: (i) the particular user has not responded to an electronic message from the other user for a response period of time, and/or (ii) the particular user has not sent an electronic message to the other user and there is less than a threshold of remaining time in the activated period.

In other implementations of the present disclosure, a server computing device is disclosed. The server computing device can include one or more processors and a non-transitory, computer readable medium storing instructions that, when executed by the one or more processors, cause the server computing device to perform operations. The operations can include receiving an indication from a first user computing device associated with a first user. The indication can be indicative of interest of the first user in connecting with a second user. The operations can further include receiving an indication from a second user computing device associated with the second user, where the indication is indicative of interest of the second user in connecting with the first user.

The operations can additionally include generating a temporary contact address for each of the first and second users. Each temporary contact address can be active for an activated period of time, which can be a fixed or editable amount of time. Also, the operations can include outputting the temporary contact address associated with the second user to the first user, and outputting the temporary contact address associated with the first user to the second user. The operations can further include forwarding, to the second user, any electronic communication from the first user addressed to the temporary contact address associated with the second user during the activated period. Additionally, the operations can include forwarding, to the first user, any electronic communication from the second user addressed to the temporary contact address associated with the first user during the activated period.

Additionally or alternatively, the operations can include outputting a reminder message to each particular user of the first and second user when: (i) the particular user has not responded to an electronic message from the other user for a response period of time, and/or (ii) the particular user has not sent an electronic message to the other user and there is less than a threshold of remaining time in the activated period.

Further areas of applicability of the present disclosure will become apparent from the detailed description provided hereinafter. It should be understood that the detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a diagram of an example computing system including a server computing device and user computing devices according to some implementations of the present disclosure;

FIG. 2 is a functional block diagram of the example user computing device of FIG. 1;

FIG. 3 is a functional block diagram of the example server computing device of FIG. 1;

FIG. 4 is a view of a display of the example user computing device of FIG. 1. displaying an example user profile according to some implementations of the present disclosure;

FIG. 5 is a view of a display of the example user computing device of FIG. 1. displaying an example reminder message according to some implementations of the present disclosure;

FIG. 6 is a view of a display of the example user computing device of FIG. 1. displaying another example reminder message according to some implementations of the present disclosure; and

FIG. 7 is a flow diagram of an example method for generating automated reminders for a computer-based dating service according to some implementations of the present disclosure.

### DETAILED DESCRIPTION

As mentioned above, computer-based dating services are increasingly being utilized to connect people (herein referred to as “users”) for dating and other social purposes. Such dating services typically allow a user to select one or more other users from a pool of other users with which the user is interested in connecting. Some dating services attempt to limit the pool of other users that is presented to a user by including in the pool only those other users that sufficiently match pre-defined criteria (sex, height, sharing of a similar interest, etc.) of the user.

The level of interest and social connection between potential mates is an elusive and mysterious phenomenon. The saying “opposites attract” was most likely coined to help explain why two people that are a seemingly poor match for a relationship actually turn out to have a strong social connection. Further, two people that are seemingly “perfect for each other” can fail to make a meaningful connection because they do not share the special “spark” or “chemistry” necessary for a dating relationship. Thus, notwithstanding the selectivity and success of dating services that attempt to make a “match” between users, it is very common for a user's interest level to change after connecting with (talking to, exchanging messages with, meeting in person with, etc.) another user.

Additionally, after an initial connection, it is not uncommon for one user to desire to pursue a dating relationship, while the other user is uninterested in doing so. One user may attempt to be nice and “let them down easily” by merely being unresponsive to the other user's messages. In some cases, the other user will not draw the appropriate conclusion from the lack of communication, and will continue to pursue the uncommunicative user. For this and other reasons, it may be beneficial for users to avoid exchanging their personal and permanent contact information (email address, phone number, etc.) during the initial stages of a potential relationship.

The present disclosure is directed to an improved computer-based dating method and system that addresses the issues described above, as well as other known problems with existing computer-based dating services.

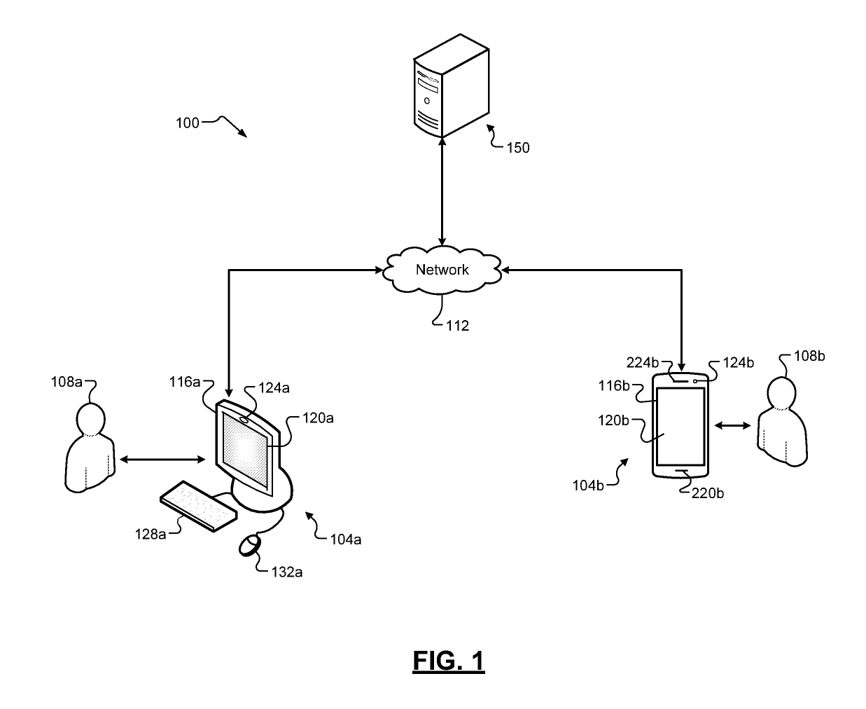

Referring now to FIG. 1, a diagram of an example computing system 100 is illustrated. The computing system 100 can include user computing devices 104a and 104b (referred to herein individually and collectively as “user computing device(s) 104”) that are operated by users 108a and 108b (referred to herein individually and collectively as “user(s) 108”), respectively. The user computing devices 104 can be configured to communicate with each other via a network 112. Examples of the user computing devices 104 include desktop computers, laptop computers, tablet computers, and mobile phones. Although in FIG. 1 the user computing device 104a is illustrated as a desktop computer and the user computing device 104b is illustrated as a smart phone, the user computing devices 104 can take any form. Further, while two computing devices 104 are illustrated, it should be appreciated that the computing system 100 can include any number of computing devices 104. The network 112 can include a local area network (LAN), a wide area network (WAN), e.g., the Internet, or a combination thereof.

The user computing devices 104 can include integrated and peripheral components. The computing devices 104 include displays 116a and 116b (referred to herein individually and collectively as “display(s) 116”) having display areas 120a and 120b (referred to herein individually and collectively as “display area(s) 120”), respectively. In some implementations, the displays 116 are touch displays. The computing devices 104 can also include cameras 124a and 124b (collectively “cameras 124”). The cameras 124 can each be configured to capture image and video data with respect to its respective computing device 104. For example, the cameras 124 can be configured to capture image and video data of the users 108. The computing devices 104 can also include other input/output devices, such as a mouse 132a (referred to herein individually and collectively as “mouse/mice 132”), a keyboard 128a (referred to herein individually and collectively as “keyboard(s) 128”), a speaker 224b (referred to herein individually and collectively as “speaker(s) 224”), and a microphone 220b (referred to herein individually and collectively as “microphone(s) 220”).

The computing system 100 can further include a server computing device 150 that is configured to communicate with the user computing devices 104 via the network 112. As used herein, the term “server computing device” can refer to any suitable hardware computer server, as well as both a single server and multiple servers operating in a parallel or distributed architecture.

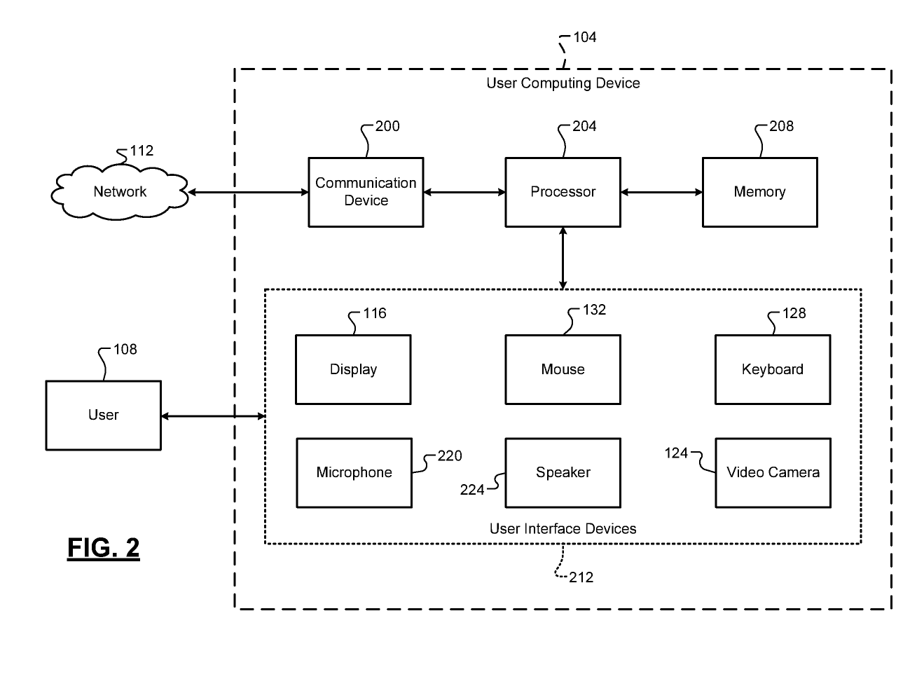

Referring now to FIG. 2, a functional block diagram of one example user computing device 104 is illustrated. While a single user computing device 104 and its associated user 108 and example components are described and referred to hereinafter, it should be appreciated that both user computing devices 104 can have the same or similar configuration and thus can operate in the same or similar manner. The user computing device 104 can include a communication device 200, a processor 204, and a memory 208. The user computing device 104 can also include the display 116, the mouse 132, the keyboard 128, the camera 124, the microphone 220, and the speaker 224 (referred to herein individually and collectively as “user interface device(s) 212”). The user interface devices 212 are configured for interaction with the user 108.

The communication device 200 is configured for communication between the processor 204 and other devices, e.g., the other user computing device 104 and the server computing device 150, via the network 112. The communication device 200 can include any suitable communication components, such as a transceiver. The communication device 200 can then handle transmission and receipt of the various communications between the user computing devices 104 and/or the server computing device 150. The memory 208 can be configured to store information at the user computing device 104. The memory 208 can be any suitable storage medium (flash, hard disk, etc.).

The processor 204 can be configured to control operation of the computing device 104. It should be appreciated that the term “processor” as used herein can refer to both a single processor and two or more processors operating in a parallel or distributed architecture. The processor 204 can be configured to perform general functions including, but not limited to, loading/executing an operating system of the computing device 104, controlling communication via the communication device 200, and controlling read/write operations at the memory 208. The processor 204 can also be configured to perform specific functions relating to at least a portion of the present disclosure, which are described in greater detail below.

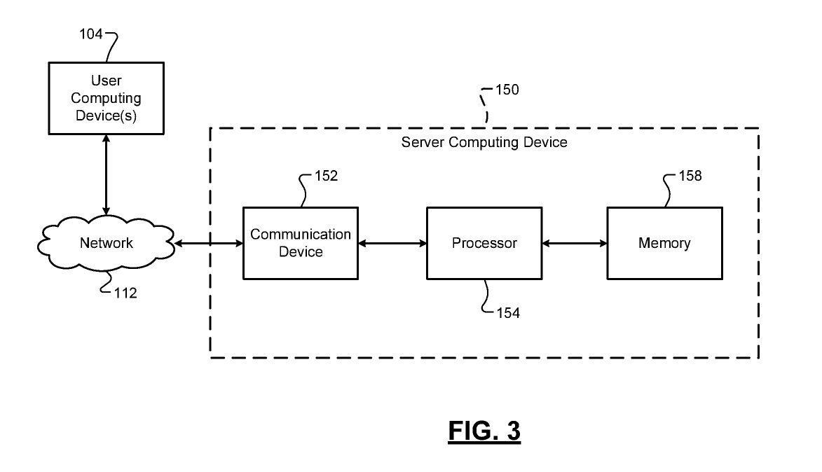

Referring now to FIG. 3, a functional block diagram of the server computing device 150 is illustrated. It should be appreciated that the server computing device 150 can have the same or similar structure to the user computing devices 104 described above. The server computing device 150 can include a communication device 152, a processor 154, and a memory 158. As described above, the term “processor” as used herein can refer to both a single processor and multiple processors operating in a parallel or distributed architecture. The communication device 152 can include any suitable communication components (e.g., a transceiver) for communication via the network 112. The memory 158 can be any suitable storage medium (flash, hard disk, etc.) for storing information at the server computing device 150. The processor 154 can control operation of the server computing device 150 and can implement at least a portion of the methods of the present disclosure, which are described in greater detail below.

As mentioned above, the present disclosure relates to a computer-based dating method and system. While the disclosure will be described in regard to the user computing devices 104 and the server computing device 150, it should be appreciated that a greater or fewer number of computing devices can be utilized. Furthermore, it should also be appreciated that, while each feature or element of the present disclosure may be described as being performed by a specific computing device, such features or elements could instead be performed by another computing device or computing devices, alone or in combination with the specific computing device described.

In some embodiments of the present disclosure, a user 108 of the computer-based dating method and system can be presented with a profile of each of one or more other users 108 in which the user 108 may be interested in connecting socially. For example only, a user 108 may be presented with one profile of another user per day. The particular user profile presented to the user 108 may be determined (e.g., by the server computing device 150) based on an algorithm that “matches” users based on shared interests, proximity between users, expressed desires of the user(s), etc. The user profile can be transmitted from the server computing device 150 to the user computing device 104 associated with the user 108.

The user 108 can review the user profile and determine whether or not the user 108 is interested in socially connecting with the other user associated with the presented user profile. The user 108 can, via his/her user computing device 104, can provide an indication to the server computing device 150 that is indicative of the interest of the user 180 in connecting with the other user. In some examples, if the user 108 has indicated that he/she is not interested in socially connecting with the other user, the user profile associated with the user 108 will not be presented to the other user. Thus, the various user profiles presented to a user 108 may include some other users that have indicated an interest in socially connecting with the user 108, as well as some other users that have not yet been presented with the user profile of the user 108.

As mentioned above, when a user 108 indicates that she/he is interested in socially connecting with another user, the user profile associated with the user 108 will be presented to the other user. In the event that the other user indicates that he/she is not interested in socially connecting with the user 108, the user 108 may be presented with a notification that the other user is not interested. Alternatively, the user 108 may not be presented with any notification that the other user is not interested. In these embodiments, the user 108 may only ascertain that the other user is not interested by concluding that, after a certain period of time, there has been no response to the user's 108 indication of interest.

The user profile presented to the user 108 will not, in some embodiments, include any indication of whether or not the associated other user has seen the profile of the user 108 and has indicated that the other user is interested in socially connecting with the user 180. In this manner, a user 108 will not know whether or not any other user is interested in socially connecting with the user 108 unless and until the user 108 has indicated that the user 108 is interested in socially connecting with the other user. This “asymmetric matching” of users provides the benefit that a user 108 can freely indicate his/her interest in socially connecting with other users with the understanding that such interest will be revealed/communicated to the other user if, and only if, the other user is also interested in socially connecting with the user 108.

Once the server computing device 150 receives an indication from both a first user 108a and another user 180b that both users 108 are interested in connecting with each other, a temporary contact address for each of the first user 108a and the second user 108b is generated. The temporary contact addresses can be any form of address that a user can utilize to connect with another user. Examples of the form that a temporary contact address can take include, but are not limited to, a phone number (for telephone calls, Short Messaging Service (SMS) messages, etc.), an email address, and a chat name or address for a chat application.

The temporary contact addresses can be output to the users, e.g., the temporary contact address for the first user 108a can be output to the other user 108b and the temporary contact address for the other user 108b can be output to the first user 108a. The users 108 can connect socially with one another by talking and/or exchanging electronic messages by utilizing the temporary contact addresses. Additionally, the temporary contact addresses can be active for a limited amount of time, which is referred to herein as an activated period of time. Because the temporary contact addresses expire after the activated period, the users 108 will not be able to communicate with one another outside of the activated period by using the temporary contact addresses. In this manner, users 108 can automatically stop receiving communications from other users 108 and let the social connection expire without further input. If further communication is desired by both users 108, the users 108 may, e.g., exchange their permanent contact information. Such a configuration allows a user 108 to “let another user down easily” as discussed above.

In some embodiments, the server computing device 150 will receive all messages sent to the temporary contact addresses of the users 108. During the activated period, the server computing device 150 will forward any electronic communication (text message, email, phone call, etc.) to the users 108, as described more fully below. Furthermore, any electronic communication received by the server computing device 150 after the activated period (when the temporary contact addresses are deactivated) will not be forwarded to the users 108.

In order to receive electronic communications from other users, a user 108 can register and/or form an account with the server computing device 150. During the registration process, a user 108 can provide his or her personal and permanent contact address/addresses (email address, phone number, etc.), as well as other information (user preferences, etc.). During the activated period, any electronic communication sent to the temporary contact address of the user 108 will be forwarded to the user 108 via the user's personal and permanent contact address/addresses by the server computing device 150. The user 108 can also set up user preferences, during or after registering, that govern how electronic communications will be forwarded to the user 108. Alternatively or additionally, the user 108 can receive electronic communications sent to his/her temporary contact address directly from the server computing device 150. For example only, the user 108 can utilize a messaging application and/or access a web page on her/his user computing device 104 to receive electronic communications forwarded by the server computing device 150. It should be appreciated that the term “forwarding” an electronic communication by the server computing device 150 is intended to encompass any and all of the above examples of the user 108 receiving an electronic communication.

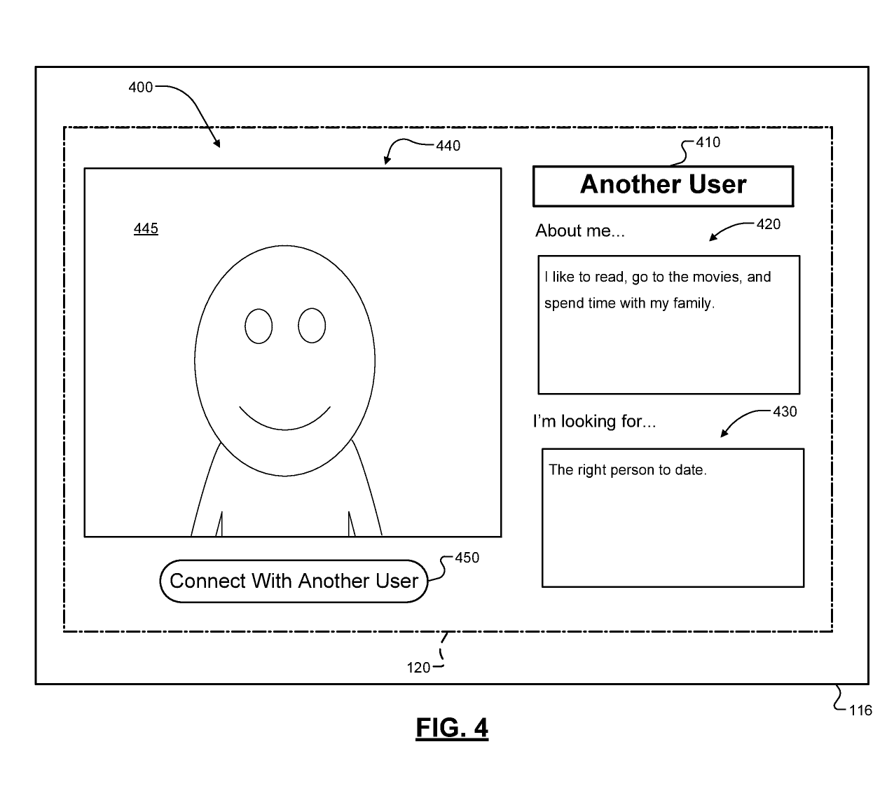

Referring now to FIG. 4, a diagram of the display 116 of an example user computing device 104 that is displaying an example user profile 400 for a computer-based dating service is illustrated. The user profile 400 can include a name portion 410 that identifies the name (“Another User”) of the user 108 associated with the user profile 400. The name in the name portion may or may not be the actual name of the other user 108, but is meant to provide a way to identify and distinguish the other user 108 to users 108 that review the user profile 400. The user profile can also include, e.g., a biography portion 420 and a goal portion 430. The biography portion 420 can include a brief description of the user 108 associated with the user profile 400, which may be input by the user 108. The goal portion 430 can include a brief description of what the user 108 associated with the user profile 400 is hoping to achieve through/obtain from the computer-based dating service.

In various embodiments, the user profile 400 can include a picture portion 440 that shows a picture or pictures 445 of the user 108 associated with the user profile 400. The pictures 445 can be input by the user 108. The user profile 400 can additionally include a selectable button 450 or other user interface element that a user 108 can select to indicate that a user 108 is interested in connecting with the other user 108 (“Another User”) associated with the user profile 400. It should be appreciated that the illustrated user profile 400 is merely an example and any form of user profile may be used with the present disclosure.

The user profile 400 can be presented to a user 108 (such as first user 108a) by the server computing device 150. For example only, the server computing device 150 may present one user profile 400 per day to the first user 108a by sending an email or other form of electronic communication/message to the first user 108a at 12:00 p.m. local time of the first user 108a. Presenting one user profile 400 per day to users 108 can have certain benefits over the more typical presentation method in which a (long) list of users 108 is presented to the first user 108a for his/her review. By presenting one user profile 400 per day, the first user 108a may spend more time reviewing the present user profile 400, and the first user 108a may be more likely to seriously consider socially connecting with the user 108 associated with the presented user profile 400. Additionally, it is common for users 108 to be overwhelmed by the number of user profiles 400 when presented with an almost infinite list of other users 108 with whom he/she may wish to socially connect. By limiting the presentation of user profiles 400 to one per day, the chances of making a meaningful social connection between users 108 may increase, somewhat dramatically, and users 108 may be more likely to continue using the dating service.

As described above, the server computing device 150 can receive an indication from a first user 108a that is indicative of interest of the first user 108a in connecting with another user (such as, the second user 108b). In some embodiments, the first user 108a will transmit the indication from his/her associated user computing device 104a by selecting the selectable button 450 or other user interface element in the presented user profile 400. It should be appreciated that any form of transmitting the indication of interest is contemplated and could be used in concert with the present disclosure.

As mentioned above, in response to receiving indications of interest in socially connecting from two users (such as first user 108a and second user 108b), temporary contact addresses can be generated and output to the users 108. In some embodiments, the temporary contact addresses can comprise phone numbers or other form of addresses that are associated with the dating service/server computing device 150. In this manner, all electronic communications from the first user 108a to the second user 108b (and vice versa) will be received by the server computing device 150. During the activated period, the server computing device 150 can forward any electronic communication from the first user 108a and addressed to the second user 108b to the permanent contact address of the second user 108b, and vice versa. Similarly, any electronic communications sent after the temporary contact addresses have been deactivated will not be forwarded by the server computing device 150.

Because the temporary contact addresses expire, the server computing device 150 can re-use particular temporary contact addresses over and over again. In some embodiments, the server computing device 150 can select a temporary contact address for a user 108 from a pool of temporary contact addresses. Each temporary contact address (such as, a phone number) may have a cost to the dating service associated with generating, utilizing, and/or maintaining the temporary contact address. By allowing re-use of temporary contact addresses, the dating service may be able to limit the total number of temporary contact addresses in the pool, thereby reducing the cost to generate and/or maintain a larger number of temporary contact addresses.

In some embodiments of the present disclosure, the temporary nature of the temporary contact addresses can pose an issue for some users 108. Specifically, it is common for a user 108 to have a very busy and demanding life due, e.g., to work demands, family demands, overscheduling of activities, and other factors. A user 108 may receive a temporary contact address of another user 108, or even an electronic communication from another user 108, and fail to immediately respond/send an electronic communication to the other user 108, due to the user's 108 unavailability at the moment (e.g., he/she is busy at work, out of town travelling, or participating in an activity). In these situations, the user 108 would typically add a task to her/agenda (mental or otherwise) to send an electronic communication to the other user 108 when he/she becomes available.

Notwithstanding these good intentions, it is not uncommon for a busy user 108 to forget to send the electronic communication for a period of time. Because the temporary contact address may be the only way to get in contact with the other user 108, if the user 108 fails to send an electronic communication to the other user 108 during the activated period, there may be no other way to socially connect with the other user 108 and the user 108 will fail to connect with someone in whom she/he is interested. Thus, while the temporary nature of temporary contact addresses provides many benefits, as described above, there may also be disadvantages associated with this arrangement. The present disclosure addresses these disadvantages by providing a system and method for automatically generating a reminder message that can be output to users 108 under certain circumstances.

In accordance with various implementations of the present disclosure, the server computing device 150 can generate and output a reminder message to a user 108 (such as first user 108a) in order to provoke use of a temporary contact address by the user 108a to socially connect with another user 108 (such as second user 108b). In various examples, the server computing device 150 may generate and output the reminder message when the particular user 108a has not responded to an electronic message from the other user 108b for a certain period of time (referred to herein as a “response period” of time). In this manner, the particular user 108a may be gently reminded or “nudged” to respond to the electronic communication of the other user 108b at an appropriate time.

The determination of what constitutes an “appropriate time” and, consequently, what the response period of time should be can be based on many factors. There may be many objectives for the dating service and the reminder message, and some of these objectives may be at odds with each other. For example only, some objectives of the dating service may be to ensure that the users 108 are socially connecting and that the resources (e.g., the temporary contact addresses) of the dating service are being utilized. Outputting a reminder message, of course, may assist in achieving these objectives by reminding the user 108a to send an electronic communication before the temporary contact address associated with the other user 108b expires. After all, the user 108a has expressed an interest in socially connecting with the other user 108b and has only a limited amount of time to do so. Thus, if these were the sole objectives of the dating service, the server computing device 150 could output a reminder message to the user 108a every hour until the user 108a sends an electronic communication to the other user 108b.

There are likely to be other objectives of the dating service that would not be served, and may be thwarted, by sending numerous reminder messages to the users 108. For example only, other objectives of the dating service could include providing a good user experience for users 108 and limiting the intrusiveness into and interruption of the daily lives of users 108. Users 108 may prefer to receive a reminder message only when necessary to limit the number of messages received and their associated interruption. If a user 108 has recently received an electronic communication, the user 108 may intend to respond when she/he is next available. Accordingly, a reminder message sent before the user 108 is available is likely to be viewed by the user 108 as unnecessary at best, and an unwelcome nuisance at worst. Thus, while continuous and unlimited reminder messages may assist with the objectives of ensuring that users 108 are communicating and resources are being utilized, the objectives of providing a good user experience and not being intrusive will likely be thwarted. Based on the above, the determination of the appropriate response period of time may be an important factor to achieving the objectives of the dating service.

In some embodiments, the response period of time is based on remaining time in the activated period. For example only, if the activated period is one week (from Day 1 to Day 7), and another user 108b has sent an electronic communication to the user 108a on Day 1, it may be appropriate to specify the response period of time to be three days. In this example, the remaining time in the activated period is six days (the electronic communication was sent on Day 1 and the activated period ends after Day 7). Thus, specifying the response period of time to be three days, which would result in sending a reminder message on Day 4, provides enough time for the user 108a to respond without being bothered by an unnecessary reminder message, while also providing enough time for the other user 108b to respond after receiving the electronic communication from the user 108a (if desired).

In another example, however, if the activated period is again one week (from Day 1 to Day 7), and another user 108b has sent an electronic communication to the user 108a on Day 4, it may be inappropriate to specify the response period of time to be three days. In this example, the remaining time in the activated period is three days (the electronic communication was sent on Day 4 and the activated period ends after Day 7). Thus, specifying the response period of time to be three days, which would result in sending a reminder message on Day 7, may provide enough time for the user 108a to respond without being bothered by an unnecessary reminder message, but may not provide enough time for the other user 108b to respond after receiving the electronic communication from the user 108a.

According to various implementations of the present disclosure, the response period of time can be further based on remaining time in the activated period and according to a user preference. A user 108a can provide his/her user preferences to the server computing device 150 in order to specify when to be sent reminder messages. In this manner, the server computing device 150 can determine the response period of time based on when the electronic communication from the other user 108 was received and the user preferences. To the extent that the user 108 has not specified his/her user preferences, a default policy for determining the response period of time can be utilized.

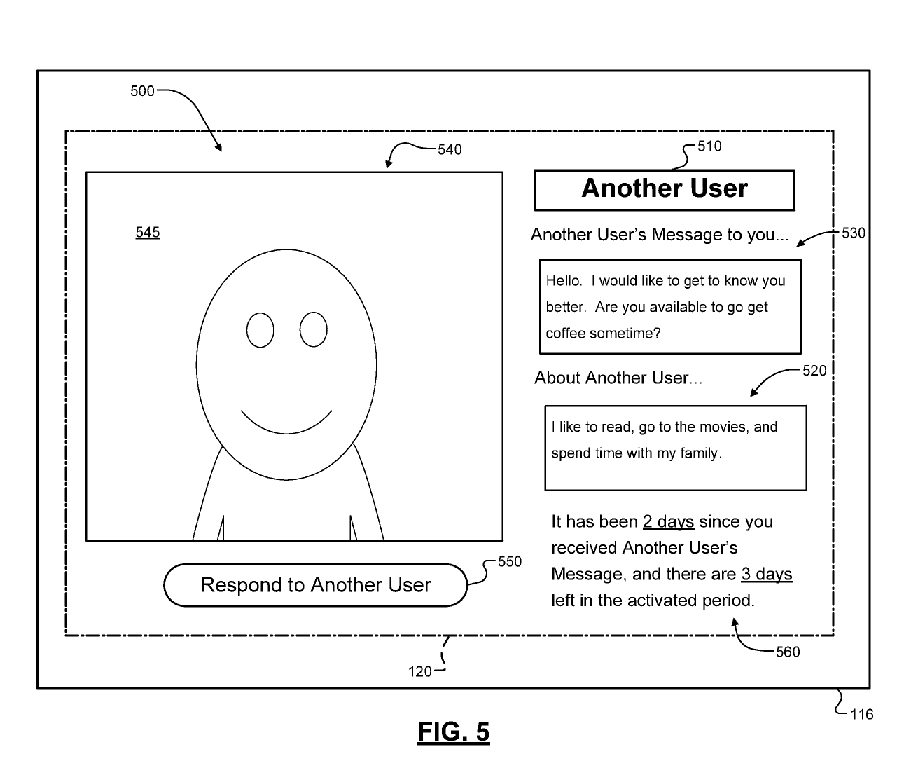

Referring now to FIG. 5, a diagram of the display 116 of an example user computing device 104 that is displaying an example reminder message 500 for a computer-based dating service is illustrated. In the illustrated example, the reminder message 500 is personalized for the user 108 to whom it will be sent to include content based on the other user 108 (“Another User”) and/or a previous electronic message/communication from the other user 108. In other embodiments, the reminder message can merely be a notification, such as a chime or vibration on a mobile phone, or a text or chat message that reminds the user 108 that he/she has not responded to an electronic communication without providing any further details.

The reminder message 500 can include a name portion 510 that identifies the name (“Another User”) of the user 108 associated with the reminder message 500. The name in the name portion may or may not be the actual name of the other user 108, but is meant to provide a way to identify and distinguish the other user 108 to a user 108 that receives the reminder message 500. The reminder message 500 can also include, e.g., a biography portion 520 and a previous message portion 530. The biography portion 520 can include a brief description of the user 108 associated with the reminder message 500, which may be the same as or different from the biography portion 420 described above in relation to the user profile 400. The previous message portion 530 can include a textual representation of the electronic communication sent by the other user 108.

In various embodiments, the reminder message 500 can also include a picture portion 540 that shows a picture or pictures 545 of the user 108 associated with the reminder message 500. The pictures 545 can be input by the user 108, and can be the same as or different from the picture(s) 445 of the user profile 400 described above. The reminder message 500 can additionally include a selectable button 550 or other user interface element that a user 108 can select to send an electronic communication (respond) to the other user 108 (“Another User”). The reminder message 500 can also include a time indicator portion 560. The time indicator portion 560 can include information relating to: (i) a time period since receiving the electronic communication from the other user 108 (“Another User”), and/or (i) a remaining time in the activated period. It should be appreciated that the illustrated reminder message 500 is merely an example and any form of reminder message may be used with the present disclosure.

In addition or as an alternative to the reminder message described above, in some embodiments the server computing device 150 can generate and output a reminder message to a user 108 (such as first user 108a) when the particular user 108a has not yet sent an electronic message to another user 108b for whom she/he has received a temporary contact address and there is less than a threshold of remaining time in the activated period. In this manner, the particular user 108a may be gently reminded or “nudged” to socially connect with the other user 108b before the temporary contact address expires. In some implementations, this reminder message will only be output to the user 108a when the other user 108b has also not yet sent an electronic communication, while in other implementations this reminder message can be output whether or not the other user 108b has sent an electronic communication.

The threshold of remaining time can be based on remaining time in the activated period. For example only, if the activated period is one week (from Day 1 to Day 7), and a user 108a has not yet sent an electronic communication to another user 108b on Day 1, it may be appropriate to specify the threshold of remaining time to be four days. In this example, the remaining time in the activated period is six days (the electronic communication was sent on Day 1 and the activated period ends after Day 7). Thus, specifying the threshold or remaining time to be four days, which would result in sending a reminder message on Day 3, provides enough time for the user 108a to respond without being bothered by an unnecessary reminder message, while also providing enough time for the other user 108b to respond after receiving the electronic communication from the user 108a (if desired).

Continuing with the example above, if the user 108a has not yet sent an electronic communication to another user 108b on Day 4, and the previously output reminder message did not provoke an electronic communication, it may be appropriate to specify the threshold of remaining time to be two days. Thus, specifying the threshold or remaining time to be two days, which would result in sending a reminder message on Day 5, provides enough time for the user 108a to respond without being bothered by another unnecessary reminder message, while also providing enough time for the other user 108b to respond after receiving the electronic communication from the user 108a (if desired).

In some implementations, only one reminder message—of any type and due to any circumstances (there is less than a threshold of remaining time in the activated period, the user 108 has not responded to an electronic communication for a response period of time, etc.)—is sent to any user 108. In this manner, a user 108 is only reminded once for each other user 108 in whom they are interested in socially connecting. This provides for the user 108 to have a second chance to remember to communicate with the other user 108 without overwhelming the user 108 with a large number of reminder messages.

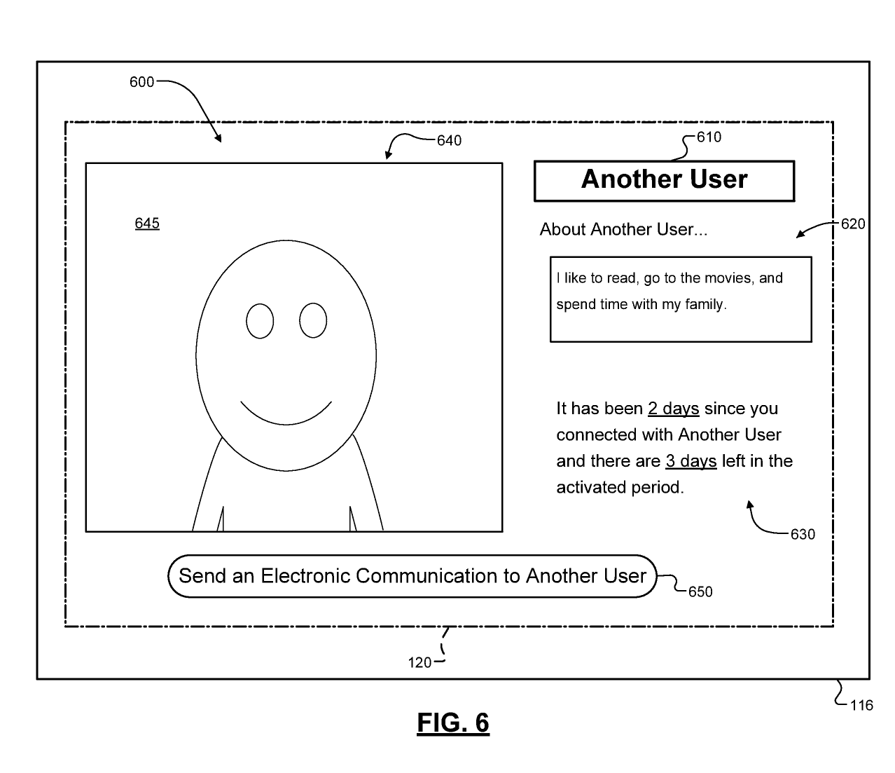

Referring now to FIG. 6, a diagram of the display 116 of an example user computing device 104 that is displaying another example reminder message 600 for a computer-based dating service is illustrated. In the illustrated example, the reminder message 600 is personalized for the user 108 to whom it will be sent to include content based on the other user 108 (“Another User”). In other embodiments, the reminder message can merely be a notification, such as a chime or vibration on a mobile phone, or a text or chat message that reminds the user 108 that he/she has not yet sent an electronic communication to the other user 108 without providing any further details.

The reminder message 600 can include a name portion 610 that identifies the name (“Another User”) of the user 108 associated with the reminder message 600. The name in the name portion may or may not be the actual name of the other user 108, but is meant to provide a way to identify and distinguish the other user 108 to a user 108 that receives the reminder message 600. The reminder message 600 can also include, e.g., a biography portion 620. The biography portion 620 can include a brief description of the user 108 associated with the reminder message 600, which may be the same as or different from the biography portion 420 described above in relation to the user profile 400.

In various embodiments, the reminder message 600 can also include a picture portion 640 that shows a picture or pictures 645 of the user 108 associated with the reminder message 600. The pictures 645 can be input by the user 108, and can be the same as or different from the picture(s) 445 of the user profile 400 described above. The reminder message 600 can further include a time indicator portion 630. The time indicator portion 630 can include information relating to (i) a time period since socially connecting with the other user 108 (“Another User”), i.e., since the beginning of the activated period, and/or (i) a remaining time in the activated period. The reminder message 600 can additionally include a selectable button 650 or other user interface element that a user 108 can select to send an electronic communication to the user 108 (“Another User”). It should be appreciated that the illustrated reminder message 600 is merely an example and any form of reminder message may be used with the present disclosure.

In some embodiments, the activated period of time can be a set, predetermined period of time, such as the one week example described above. In other embodiments, however, the activated period of time can be flexible such that the server computing device 150 can alter the activated period based on behavior of the users 108 associated with the activated period. For example only, if a user 108 (such as first user 108a) does not respond to an electronic message of another user (such as second user 108b) for a period of time, and further does not respond to the other user 108b for another period of time after receiving one or more reminder messages, the server computing device 150 may alter the activated period by shortening the activated period. In this example, if the user 108a does not respond to a reminder message for a reminder response period of time, the server computing device 150 can cause the temporary contact addresses to expire immediately after the reminder response period of time. In this manner, the dating service can more effectively manage its resources (e.g., temporary contact addresses) such that the resources are better utilized to create meaningful social connections between users 108.

Conversely, when the behavior of the users 108 associated with the activated period indicate a significant amount of back-and-forth communication between users 108 utilizing the temporary contact addresses, the server computing device 150 may alter the activated period to extend its length. A notification that the activated period has been extended can be sent to both users 108, e.g., including an indication of the new end date of the activated period, to allow the users 108 to exchange alternate addresses for further communication.

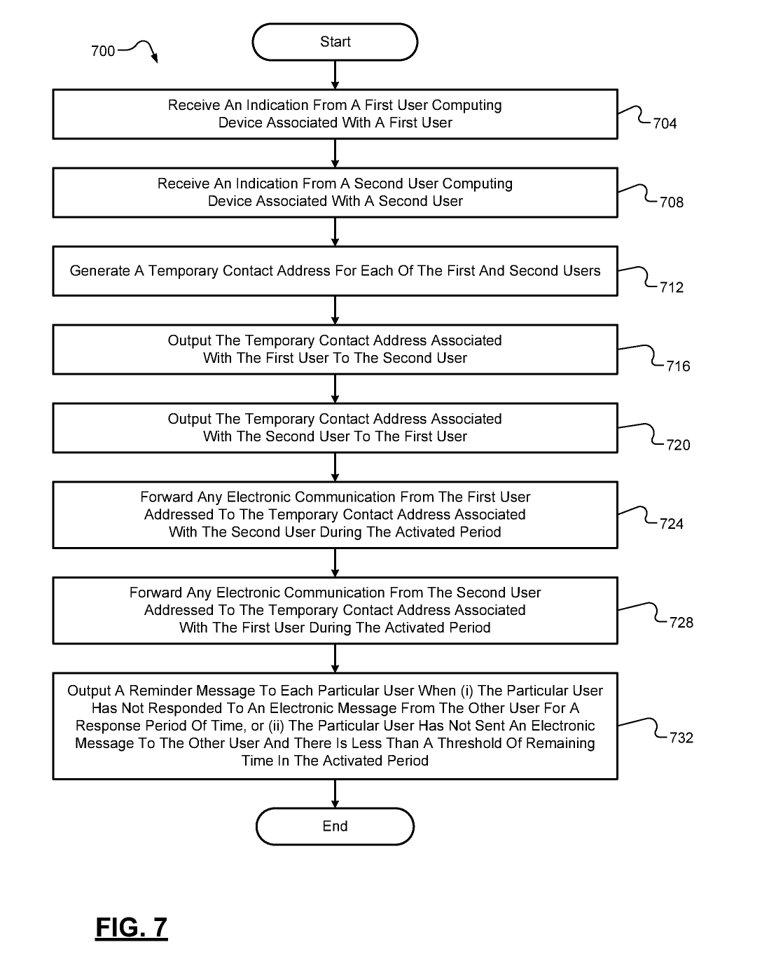

Referring now to FIG. 7, a flow diagram of an example method 700 for generating automated reminders for a computer-based dating service in accordance with some implementations of the present disclosure is illustrated. For ease of description, the technique 700 will be described in reference to being performed by the server computing device 150, but it should be appreciated that the method 700 can also or alternatively be performed by a user computing device 104, two or more user computing devices 104 operating in a parallel or distributed architecture, and/or any one or more particular components of the server computing device 150 and/or one or a plurality of user computing devices 104.

At 704, the server computing device 150 can receive an indication from a first user computing device 104a associated with a first user 108a. As mentioned above, the indication can be indicative of interest of the first user 108a in connecting with a second user 108b. Similarly, at 708 the server computing device 150 can receive an indication from a second user computing device 104b associated with the second user 108b that is indicative of interest of the second user 108b in connecting with the first user 108a. The server computing device 150 can generate a temporary contact address for each of the first and second users 108a, 108b at 712. The server computing device 150 can output the temporary contact address associated with the first user 108a to the second user 108b (at 716), and the temporary contact address associated with the second user 108b to the first user 108a (at 720).

At 724, the server computing device 150 can forward, to the second user 108b, any electronic communication from the first user 104a that is addressed to the temporary contact address associated with the second user 108b during the activated period. Similarly, at 728, the server computing device 150 can forward, to the first user 108a, any electronic communication from the second user 104b that is addressed to the temporary contact address associated with the first user 108a during the activated period. As mentioned above, the activated period can be a predetermined period of time, and can also be flexible and subject to alternation by the server computer device 150. In some embodiments, outside of the activated period the server computing device 150 will not forward any receive electronic communications.

As described above, the server computing device 150 can output a reminder message to each particular user of the first and second user 108a, 108b under certain circumstances. In the illustrated example method 700 and at 732, the server computing device 150 will output a reminder message to each particular user of the first and second user when: (i) the particular user has not responded to an electronic message from the other user for a response period of time, or (ii) the particular user has not sent an electronic message to the other user and there is less than a threshold of remaining time in the activated period. The method 700 can then end or return to 704 for one or more additional cycles.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known procedures, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The term “and/or” includes any and all combinations of one or more of the associated listed items. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

The techniques described herein may be implemented by one or more computer programs executed by one or more processors. The computer programs include processor-executable instructions that are stored on a non-transitory tangible computer readable medium. The computer programs may also include stored data. Non-limiting examples of the non-transitory tangible computer readable medium are nonvolatile memory, magnetic storage, and optical storage.

Some portions of the above description present the techniques described herein in terms of algorithms and symbolic representations of operations on information. These algorithmic descriptions and representations are the means used by those skilled in the data processing arts to most effectively convey the substance of their work to others skilled in the art. These operations, while described functionally or logically, are understood to be implemented by computer programs. Furthermore, it has also proven convenient at times to refer to these arrangements of operations as modules or by functional names, without loss of generality.

Unless specifically stated otherwise as apparent from the above discussion, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system memories or registers or other such information storage, transmission or display devices.

Certain aspects of the described techniques include process steps and instructions described herein in the form of an algorithm. It should be noted that the described process steps and instructions could be embodied in software, firmware or hardware, and when embodied in software, could be downloaded to reside on and be operated from different platforms used by real time network operating systems.

The present disclosure also relates to an apparatus for performing the operations herein. This apparatus may be specially constructed for the required purposes, or it may comprise a general-purpose computer selectively activated or reconfigured by a computer program stored on a computer readable medium that can be accessed by the computer. Such a computer program may be stored in a tangible computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Furthermore, the computers referred to in the specification may include a single processor or may be architectures employing multiple processor designs for increased computing capability.

The algorithms and operations presented herein are not inherently related to any particular computer or other apparatus. Various general-purpose systems may also be used with programs in accordance with the teachings herein, or it may prove convenient to construct more specialized apparatuses to perform the required method steps. The required structure for a variety of these systems will be apparent to those of skill in the art, along with equivalent variations. In addition, the present disclosure is not described with reference to any particular programming language. It is appreciated that a variety of programming languages may be used to implement the teachings of the present disclosure as described herein, and any references to specific languages are provided for disclosure of enablement and best mode of the present invention.

The present disclosure is well suited to a wide variety of computer network systems over numerous topologies. Within this field, the configuration and management of large networks comprise storage devices and computers that are communicatively coupled to dissimilar computers and storage devices over a network, such as the Internet.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A computer-implemented method, comprising:
receiving, at a computing device having one or more processors, an indication from a first user computing device associated with a first user, the indication being indicative of interest of the first user in connecting with a second user;
receiving, at the computing device, an indication from a second user computing device associated with the second user, the indication being indicative of interest of the second user in connecting with the first user;
generating, at the computing device, a temporary contact address for each of the first and second users, each temporary contact address being active for an activated period of time;
outputting, at the computing device, the temporary contact address associated with the second user to the first user;
outputting, at the computing device, the temporary contact address associated with the first user to the second user;
forwarding, from the computing device and to the second user, any electronic communication from the first user addressed to the temporary contact address associated with the second user during the activated period;
forwarding, from the computing device and to the first user, any electronic communication from the second user addressed to the temporary contact address associated with the first user during the activated period; and
outputting, from the computing device, a reminder message to each particular user of the first and second user when:
(i) the particular user has not responded to an electronic message from the other user for a response period of time, or
(ii) the particular user has not sent an electronic message to the other user and there is less than a threshold of remaining time in the activated period.

2. The computer-implemented method of claim 1, wherein the response period of time is based on remaining time in the activated period.

3. The computer-implemented method of claim 1, further comprising deactivating each temporary contact address after the activated period, wherein any electronic communication to a deactivated temporary contact address will not be forwarded.

4. The computer-implemented method of claim 1, wherein the threshold of remaining time is based on remaining time in the activated period.

5. The computer-implemented method of claim 1, wherein the reminder message to the particular user is personalized to include content based on: (i) the other user, or (ii) a previous electronic message from the other user.

6. The computer-implemented method of claim 1, wherein the activated period is predetermined period of time.

7. The computer-implemented method of claim 1, further comprising altering the activated period when the particular user does not respond to the other user in response to the reminder message.

8. The computer-implemented method of claim 7, wherein altering the activated period comprises shortening the activated period.

9. A server computing device, comprising:
one or more processors; and
a non-transitory, computer readable medium storing instructions that, when executed by the one or more processors, cause the server computing device to perform operations comprising:
receive an indication from a first user computing device associated with a first user, the indication being indicative of interest of the first user in connecting with a second user;
receive an indication from a second user computing device associated with the second user, the indication being indicative of interest of the second user in connecting with the first user;
generate a temporary contact address for each of the first and second users, each temporary contact address being active for an activated period of time;
output the temporary contact address associated with the second user to the first user;
output the temporary contact address associated with the first user to the second user;
forward, to the second user, any electronic communication from the first user addressed to the temporary contact address associated with the second user during the activated period;
forward, to the first user, any electronic communication from the second user addressed to the temporary contact address associated with the first user during the activated period;
output a reminder message to each particular user of the first and second user when:
(i) the particular user has not responded to an electronic message from the other user for a response period of time, or
(ii) the particular user has not sent an electronic message to the other user and there is less than a threshold of remaining time in the activated period.

10. The server computing device of claim 9, wherein the response period of time is based on remaining time in the activated period.

11. The server computing device of claim 9, wherein the operations further comprise deactivating each temporary contact address after the activated period, wherein any electronic communication to a deactivated temporary contact address will not be forwarded.

12. The server computing device of claim 9, wherein the threshold of remaining time is based on remaining time in the activated period.

13. The server computing device of claim 9, wherein the reminder message to the particular user is personalized to include content based on: (i) the other user, or (ii) a previous electronic message from the other user.

14. The server computing device of claim 9, wherein the activated period is predetermined period of time.

15. The server computing device of claim 9, wherein the operations further comprise altering the activated period when the particular user does not respond to the other user in response to the reminder message.

16. The server computing device of claim 16, wherein altering the activated period comprises shortening the activated period.

17. A computer-implemented method, comprising:
receiving, at a computing device having one or more processors, an indication from a first user computing device associated with a first user, the indication being indicative of interest of the first user in connecting with a second user;
receiving, at the computing device, an indication from a second user computing device associated with the second user, the indication being indicative of interest of the second user in connecting with the first user;
generating, at the computing device, a temporary contact address for each of the first and second users, each temporary contact address being active for an activated period of time;
outputting, at the computing device, (i) the temporary contact address associated with the second user to the first user, and (ii) the temporary contact address associated with the first user to the second user;
forwarding, from the computing device and to an appropriate one of the first and second users, any electronic communication utilizing the temporary contact addresses during the activated period; and
outputting, from the computing device, a personalized reminder message to each particular user of the first and second user when:
(i) the particular user has not responded to an electronic message from the other user for a response period of time, or
(ii) the particular user has not sent an electronic message to the other user and there is less than a threshold of remaining time in the activated period,
wherein at most one personalized reminder message is sent to each particular user, and
wherein the personalized reminder message includes information based on the other user.

18. The computer-implemented method of claim 17, wherein the response period of time is based on remaining time in the activated period.

19. The computer-implemented method of claim 17, further comprising deactivating each temporary contact address after the activated period, wherein any electronic communication to a deactivated temporary contact address will not be forwarded.

20. The computer-implemented method of claim 17, wherein the threshold of remaining time is based on remaining time in the activated period.
